(19) United States
(12) Patent Application Publication
(10) Pub. No.: US 2025/0065839 A1
(43) Pub. Date: Feb. 27, 2025

(54) BELT RETRACTOR FOR A SEATBELT DEVICE OF A MOTOR VEHICLE

(71) Applicant: Autoliv Development AB, Vargarda (SE)

(72) Inventors: Bengt DAHLQUIST, Alingsas (SE); Lennart PETTERSSON, Vargarda (SE)

(21) Appl. No.: 18/729,074

(22) PCT Filed: Dec. 16, 2022
(86) PCT No.: PCT/EP2022/086270

§ 371 Date: Jul. 15, 2024

(30) Foreign Application Priority Data
Jan. 19, 2022 (DE) 10 2022 101 203.4

(51) Int. Cl. B60R 22/34; B60R 22/44

(52) U.S. Cl. CPC B60R 22/3413; B60R 22/44; B60R 2022/4406

(57) ABSTRACT

The invention relates to a belt retractor for a seatbelt device of a motor vehicle, having
a belt shaft, rotatably mounted in a frame, for winding up a seatbelt of the seatbelt device, wherein
the frame has two opposing wall sections oriented in parallel with one another and each having a bearing opening, in which wall sections the belt shaft is rotatably mounted, and
a spring housing secured to one of the wall sections and having a return spring arranged therein, which is connected to the spring housing at a first end and rotationally fixed to the belt shaft at a second end, wherein
the spring housing is radially elastically retained on the wall section.

The present invention relates to a belt retractor for a seatbelt device of a motor vehicle, having the features of the preamble of claim 1.

Belt retractors of seatbelt devices in motor vehicles are fixedly fastened to the vehicle and have a rotatably mounted belt shaft on which a seatbelt of the seatbelt device can be wound. The belt shaft is rotatably mounted in a frame fixedly fastened to the vehicle and which simultaneously serves to fixedly fasten the belt retractor to the vehicle to the vehicle structure or to a vehicle seat. Furthermore, a return spring is provided which is supported on the frame of the belt retractor and which spring-loads the belt shaft in the winding direction of the seatbelt so that the seatbelt can be pulled out by tensioning the return spring and is then retracted by the tensioned return spring after being pulled out by driving the belt shaft in the winding direction. It has proven useful to form the return spring by means of a spiral spring arranged in a spring housing, wherein the spring housing is fixed for conjoint rotation to the frame of the belt retractor and also serves to fasten the outer end of the spiral spring. The inner end of the spiral spring, which is also called the spring core, is connected to the belt shaft for conjoint rotation. Furthermore, the spiral spring is wound in such a way that it pretensions the belt shaft in the winding direction via the spring core and is fixedly supported on the vehicle by the outer end on the frame via the spring housing. The return spring is pre-assembled and fixed in the spring housing and mounted on the belt retractor together therewith as a pre-assembled assembly, also known as a spring cassette.

The frame has two opposing bearing openings, each arranged in legs of the frame oriented parallel to each other, in which the belt shaft is mounted in the radial direction with a bearing flange. During assembly, the spring cassette is placed laterally with the spring core on a central axial extension of the belt shaft and connected for conjoint rotation and fastened to one of the legs of the frame via the spring housing. The spring cassette is designed in such a way that the extension of the belt shaft can be connected to the spring core with a bearing clearance of +/−1 mm in the axial direction.

From DE 27 20 959, a belt retractor is known in which the belt shaft is additionally mounted in a point bearing in the spring housing via the axial extension on which the spring core is held.

From DE 10 2004 008 278 A1, a belt retractor is also known, in which the spring core is fixed in the spring cassette by means of a locking element to simplify assembly, which is then removed or destroyed when the spring core is connected to the axial extension of the belt shaft.

From DE 31 08 632 A1, a belt retractor is also known in which the spring cassette is fixed to the leg of the frame via several expansion pins provided on the spring housing.

A basic problem is that the return spring designed as a spiral spring does not only exert forces in the circumferential direction on the belt shaft. Due to its shape and the radially outer fastening to the spring housing in conjunction with the radially inner fastening to the belt shaft, the return spring also exerts radial forces on the belt shaft and the spring housing. These radial forces must also be absorbed by the bearing of the belt shaft and can adversely affect the winding and unwinding process of the seatbelt, e.g., by increasing friction in the bearing of the belt shaft.

Against this background, the object of the invention is to provide a belt retractor which is to be improved with regard to the winding and unwinding process of the seatbelt.

In order to achieve the object, a seatbelt retractor having the features of claim 1 is proposed. Further preferred developments of the invention can be taken from the dependent claims, the figures, and the associated description.

According to claim 1, to achieve the object, a belt retractor for a seatbelt device of a motor vehicle is proposed with a belt shaft rotatably mounted in a frame for winding up a seatbelt of the seatbelt device, wherein the frame has two opposing wall sections oriented in parallel with one another and each having a bearing opening in which the belt shaft is rotatably mounted, and a spring housing secured to one of the wall sections and having a return spring arranged therein, which is connected to the spring housing at a first end and fixed for conjoint rotation to the belt shaft at a second end, wherein the spring housing is held radially elastically on the wall section.

Due to the radially elastic holding of the spring housing on the frame or the wall section of the frame of the belt retractor, the spring housing and therefore also the first end of the return spring held thereon can carry out at least slight radial movements so that, conversely, the radial forces acting upon the belt shaft can be reduced. In particular, this allows the radial forces exerted by the return spring itself to be compensated for; the return spring practically gives way itself by allowing the first end to deflect radially outwards or inwards.

The spring housing can preferably have a main housing having fastening sections arranged radially on the outside, and the fastening sections can preferably be connected to the main housing via resilient deformation sections. Accordingly, the fastening of the spring housing is on the one hand deliberately designed to be secure, and on the other radially elastic, in that the fastening via the fastening sections is correspondingly secure, and the radially elastic mobility of the spring housing is achieved by the deformation sections deliberately provided between the main housing and the fastening sections. The radially elastic mobility of the spring housing is specifically achieved by the design and arrangement of the deformation sections, while the fastening sections can be designed with regard to a functionally reliable and correspondingly secure fastening of the spring housing.

It is further proposed that the fastening sections each be connected to the main housing via two deformation sections, and the fastening sections, together with the deformation sections provided thereon, each delimit a free space to the main housing. The advantage of this solution is that, even if there is damage to one of the deformation sections, the main housing is still connected to the fastening section via the other deformation section in a functionally reliable manner. Furthermore, the deformation sections and the fastening sections complement each other in such a way that they delimit a free space to the main housing, the deformation sections therefore form a continuous connecting line together with the fastening section arranged therebetween, and the mobility is achieved by the free space formed to the main housing and the deformability of the deformation sections.

It is further proposed that four fastening sections be provided, and in each case two fastening sections be arranged symmetrically to one another in relation to a central axis of the belt retractor. The proposed number and arrangement of the fastening sections enable a very even balance of the radial forces and in a direction-neutral manner with respect to the central axis by means of a corresponding deflection movement of the spring housing.

Furthermore, it is proposed that the fastening sections be arranged in such a way that they each form a stop, which limits the radial deflection of the spring housing made possible by the deformation sections. The radial elastic fastening of the spring housing is therefore limited to a maximum spring travel. The elastic spring travel of the spring housing is preferably dimensioned such that it is greater than the bearing clearance of the belt shaft in the bearing openings, so that the radial forces exerted by the seatbelt on the belt shaft cause the belt shaft to run in its bearing points, and the fastening sections are not loaded in this case, since the spring housing does not come into contact with the fastening sections in this case.

It is further proposed that the spring housing comprise a cover rigidly connected to the spring housing on its side that faces the wall section, and the cover have an annular, axially projecting collar which is arranged such that it engages in the bearing openings and encompasses the section of the belt shaft that passes through the bearing opening. In this case, the axially protruding collar additionally forms a bearing ring with an enlarged bearing surface in the bearing opening for the belt shaft. Additional bearing shells or bearing rings in the bearing opening can therefore be omitted.

It is further proposed that the wall section in the region of the bearing opening be thickened in the axial direction of the belt shaft. Due to the proposed further development, the wall section itself forms an enlarged contact or run-on surface for the belt shaft or a bearing ring.

It is further proposed that the return spring be connected at the second end for conjoint rotation to a coupling piece which is connected for conjoint rotation to the belt shaft. The coupling piece serves to connect to the belt shaft and for this purpose is individually provided with a multi-tooth or polygon profile, for example, while the return spring is securely attached or clamped by the second end to the coupling piece.

It is further proposed that an axial spring which urges the coupling piece into a bearing of the spring housing be provided between the coupling piece and the belt shaft. The coupling piece is connected to the belt shaft for conjoint rotation and therefore also carries out the rotational movements of the belt shaft. The proposed solution improves the bearing of the coupling piece in its movement, wherein the fixed spring housing is deliberately used for bearing and at the same time forms the attachment point for the first end of the return spring. The bearing point is preferably a spherical bearing in the form of a hemisphere or partial sphere in the spring housing which, due to its shape, can preferably absorb both axial and radial forces in a direction-neutral manner.

It is further proposed that the axial spring be a conical spring which, due to its shape, pretensions the coupling piece in both the axial and radial directions relative to the bearing point. The pretensioning of the coupling piece or the centering of the coupling piece in the radial direction can be achieved particularly easily in that the conical spring with its larger diameter abuts the belt shaft. As a result, the conical spring with the smaller diameter abuts the coupling piece and at the same time causes the coupling piece to be centered.

It is further proposed that a force limiting device be provided which has a profile head that can be blocked by means of a blocking pawl in relation to a blocking wall section of the frame, and the wall sections having the bearing openings be arranged on one side of the blocking wall section, and the bearing clearance of the bearing opening in the wall section at the greater distance from the blocking wall section be greater than the bearing clearance of the bearing opening in the wall section at the smaller distance to the blocking wall section. The proposed further development makes it possible to improve the bearing with regard to the bearing forces acting during the activation of the force limiting device, by allowing the belt shaft to be deflected at an angle and yet still run evenly in the bearing openings.

The invention is explained below using preferred embodiments with reference to the accompanying figures. In the figures:

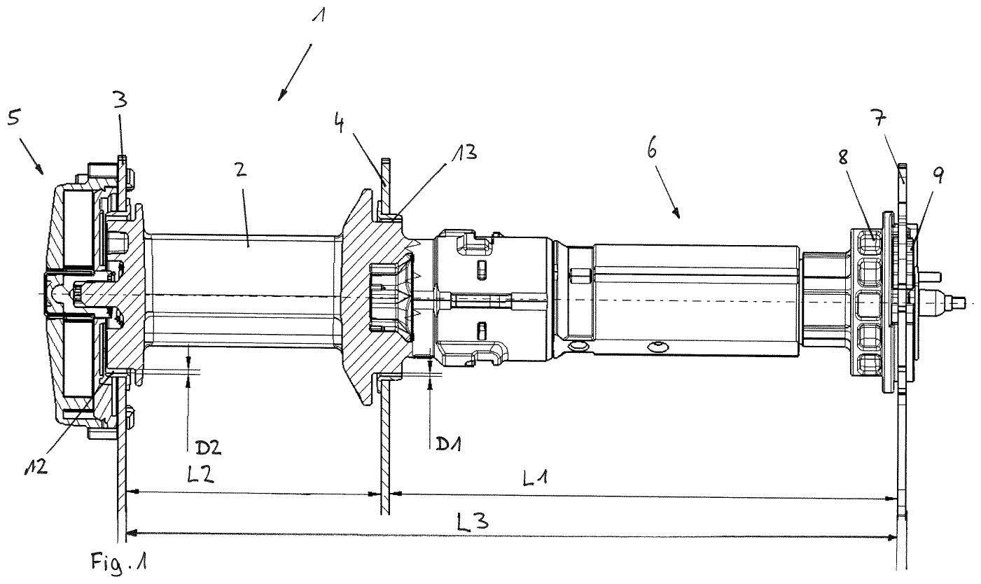

FIG. 1 shows a belt retractor with a belt shaft and a force limiting device in a sectional view of the belt shaft; and

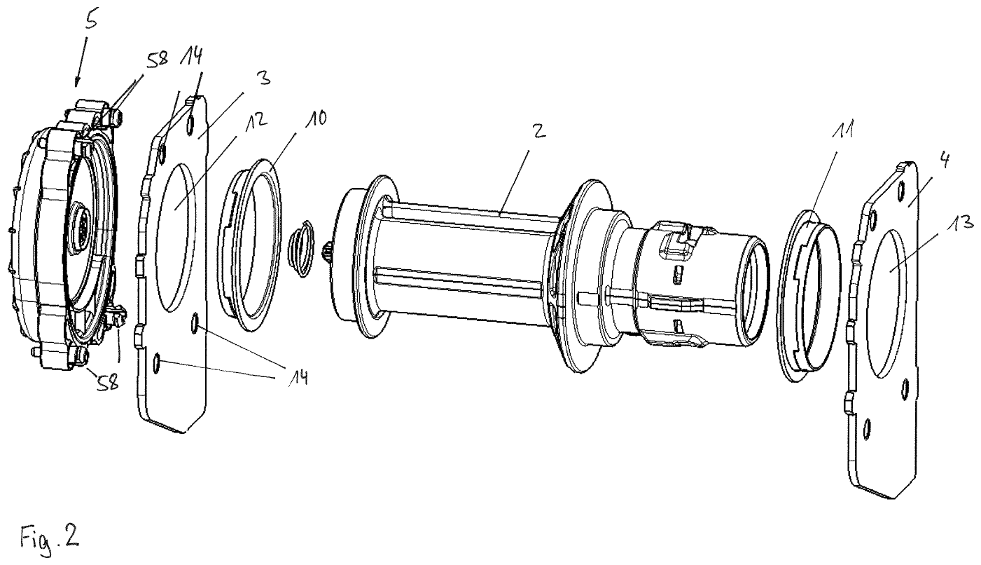

FIG. 2 shows an exploded view of the belt retractor in a first perspective; and

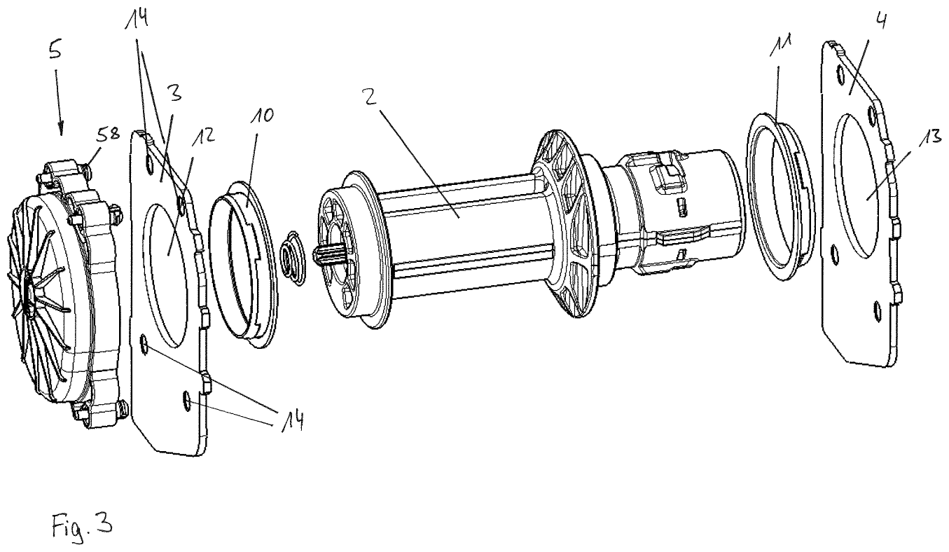

FIG. 3 shows an exploded view of the belt retractor in a second perspective; and

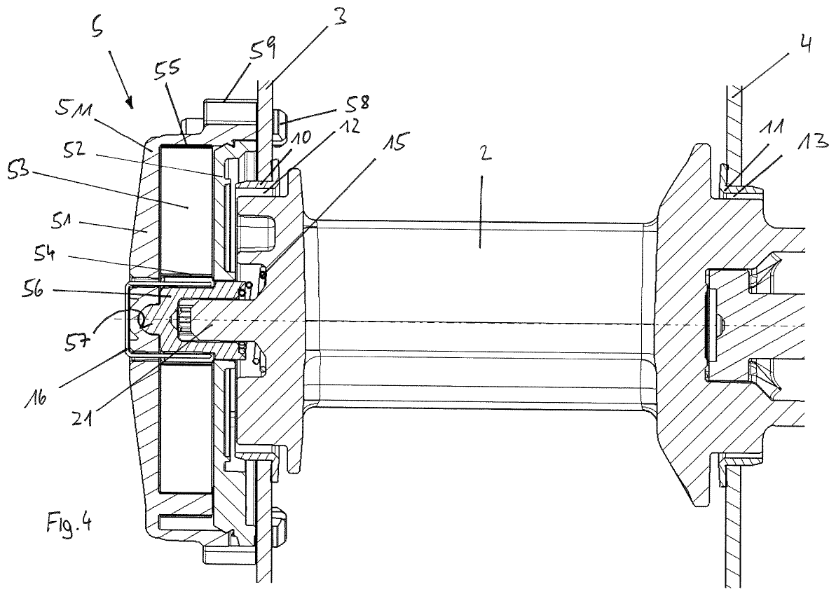

FIG. 4 shows a sectional view of the belt retractor with the belt shaft and the spring cassette; and

FIG. 5 shows an enlarged section of the spring cassette in the region of the coupling piece; and

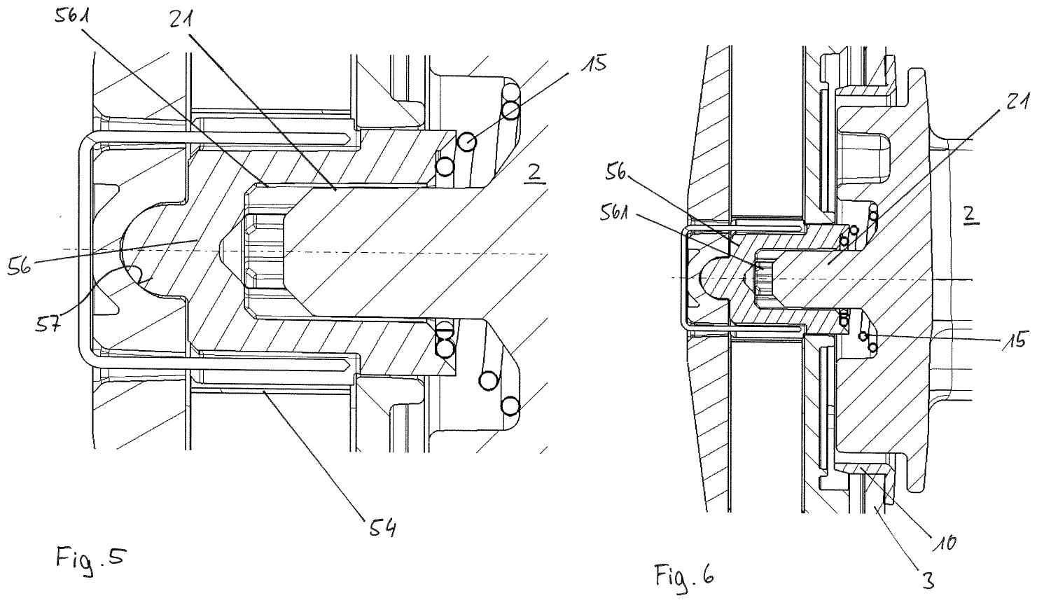

FIG. 6 shows an enlarged section of the spring cassette in the region of the coupling piece and the belt shaft; and

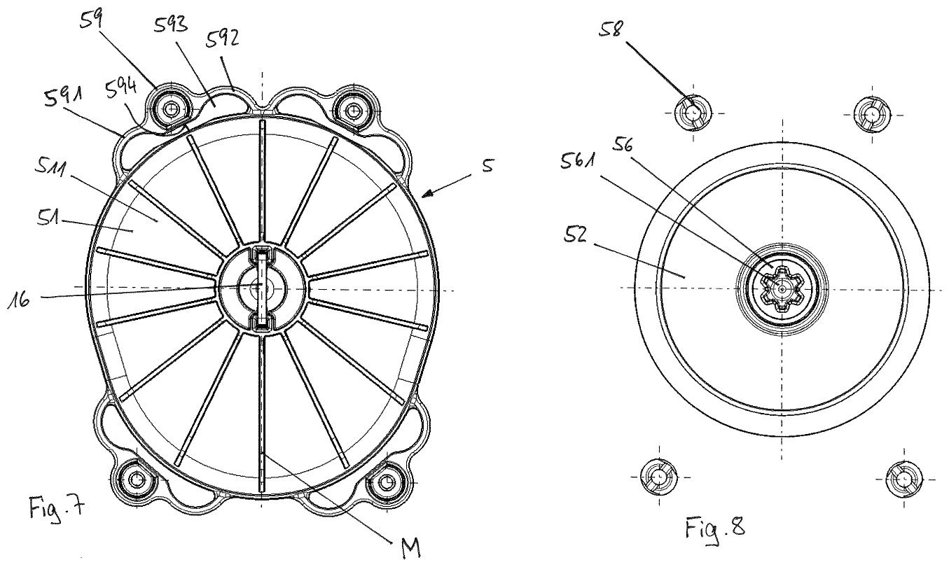

FIG. 7 reveals the spring cassette of FIG. 4 viewed from the left towards the spring housing; and

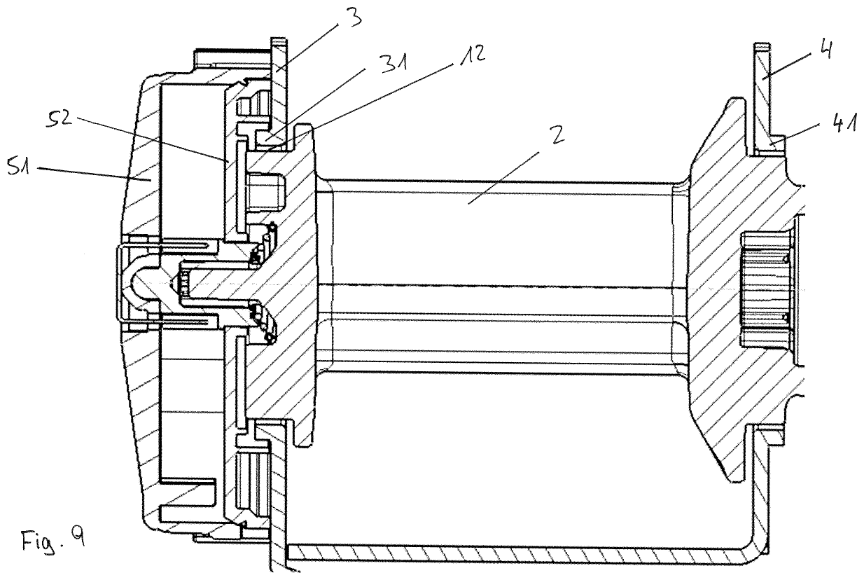

FIG. 8 shows the spring cassette 5 of FIG. 4 after fastening to the wall section viewed from the right before inserting the belt shaft; and

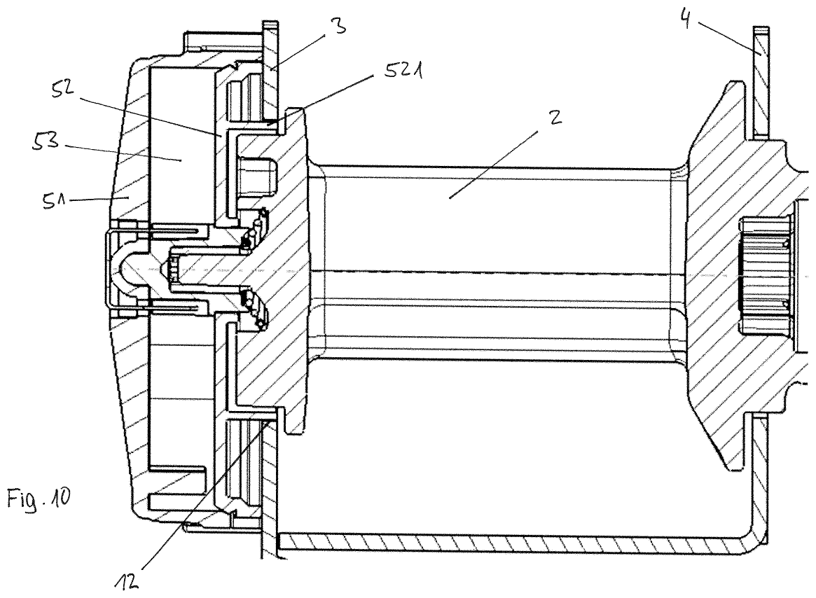

FIG. 9 shows a belt retractor with a bearing opening with a thickened wall section; and

FIG. 10 shows a belt retractor with a spring cassette with a cover with a radial annular collar.

FIG. 1 reveals a belt retractor 1 according to the invention with a belt shaft 2 and a force limiting device 6. The belt shaft 2 and the force limiting device 6 are each mounted in wall sections 3 and 4 oriented in parallel to each other. The wall sections 3 and 4 are fixed and divide the interior of a frame (not shown) which is formed from one or more profiled rails. Alternatively, the wall sections 3 and 4 can also be formed by the bent-up legs of a U-shaped frame. The wall sections 3 and 4 are fixedly fastened to the vehicle when the belt retractor 1 is in a fastened state in the vehicle.

The force limiting device 6 comprises a profile head 8 that can be blocked, fixed to the vehicle in a blocking wall section 7 via a blocking pawl 9 and one or more torsion bars which cannot be seen and which are connected or can be connected at one end to the profile head 8 and at the other end to the belt shaft 2 and, when the profile head 8 is blocked, enable a force-limited belt webbing extension of the seatbelt by means of a plastic deformation and a thereby-enabled rotation of the belt shaft 2 in the extension direction.

Furthermore, a spring cassette 5 is fastened to the left front outer side of the wall section 3, the structure of which will be explained in more detail below. The spring cassette 5 is pre-assembled and fastened as an assembly to the wall section 3 of the belt retractor 1.

In FIGS. 2 and 3, the same belt retractor 1 can be seen in an exploded view from different perspectives, but without the force limiting device 6 and the right blocking wall section 7 of FIG. 1. In each of the wall sections 3 and 4, a bearing opening 12 and 13 is provided, in each of which a bearing ring 10 and 11 is arranged. The bearing rings 10 and 11 increase the available bearing surface for the belt shaft 2 in the bearing openings 12 and 13 and therefore improve the overall bearing. Furthermore, in each of the wall sections 3 and 4, four fastening openings 14 are provided, in which the spring cassette 5 is fastened by fastening pins 58.

FIG. 4 shows the belt shaft 2 with the spring cassette 5 and the wall sections 3 and 4 in a sectional view. The belt shaft 2 extends through the bearing openings 12 and 13 in which the bearing rings 10 and 11 are arranged.

The bearing rings 10 and 11 are designed as plastic injection-molded parts and enlarge the bearing surface for the sections of the belt shaft 2 which pass through the bearing openings 12 and 13. The spring cassette 5 has a hood-shaped spring housing 51 open on one side which is closed on its open side by means of a disk-shaped cover part 52. The spring housing 51 therefore has a cavity, covered by the cover part 52, in which a spiral-shaped return spring 53 is arranged. The return spring 53 is connected by its first radially outer end 55 to the spring housing 51 and by its second radially inner end 54 for conjoint rotation to a coupling piece 56 and thereby for conjoint rotation to the belt shaft 2. For this purpose, the coupling piece 56 has a central opening 561 with a multi-tooth profile, which can be seen in FIG. 5, into which the belt shaft 2 engages with a correspondingly profiled extension 21 to realize a rotationally conjoint connection.

The spring cassette 5 is pre-assembled with a pretensioned return spring 53 by rotating the coupling piece 56 together with the radially inner second end 54 of the return spring 53 relative to the radially outer first end of the return spring 53, and then fixing it in the predetermined and pretensioned position relative to the spring housing 51 by a retaining clip 16. The coupling piece 56 is fixed in such a position that the spring cassette 5 with the pre-oriented coupling piece 56 and the multi-tooth profile arranged therein can be pushed onto the counter profile of the extension 21 and is in such a position that the fastening pins 58 of the spring housing 51 are aligned with the fastening openings 14 of the wall section 3 and can be inserted into them. After the spring cassette 5 has been installed, the retaining clip 16 is removed, at the latest after the belt retractor 1 has been installed in the vehicle, so that the return spring 53 can relax and thereby exert the necessary retraction force for winding up the seatbelt on the belt shaft 2.

Furthermore, an axial spring 15 in the form of a conical spring is provided, which is placed on the extension 21 before the spring cassette 5 is installed. The axial spring 15 has a conical shape and is pushed onto the extension 21 with the winding of the larger diameter so that it rests axially on the belt shaft 2 with this winding. When the spring cassette 5 is put on, it comes into axial contact with the coupling piece 56 on the winding of the axial spring 15 with the smaller diameter. Due to its conical shape, the axial spring 15 has a centering effect for itself and for the coupling piece 56, and presses the coupling piece 56 axially against a dome-shaped bearing point 57 in the spring housing 51. The coupling piece 56 has on its side facing the bearing point 57 a partially spherical extension, with which it comes to rest on the surface of the bearing point 57 designed as a spherical bearing and is therefore supported in both the axial and radial directions, as can be seen in FIGS. 5 and 6.

The belt shaft 2 and the coupling piece 56 are designed such that the spring cassette 5 with the coupling piece 56 can be mounted relative to the belt shaft 2 with an axial tolerance of +/−1 mm.

In FIG. 7, the spring cassette 5 of FIG. 4 can be seen, viewed from the left towards the spring housing 51. In FIG. 8, the spring cassette 5 of FIG. 4 can be seen, after being fastened to the wall section 3, viewed from the right before inserting the belt shaft 2. The spring cassette 5 is inserted with the fastening pins 58 into the fastening openings 14 of the wall section 3. The retaining clip 16 fixes the coupling piece 56 with the opening 561 and the multi-tooth profile provided therein so that the belt shaft 2 can be inserted in a predetermined orientation with the extension 21.

The fixing pins 58 extend axially from a fixing section 59 and are connected to the spring housing 51 via resilient deformation sections 591 and 592 so that, together with the fixing sections 59, they each enclose a free space 593. The deformation sections 591 and 592 are designed as curved, thin-walled webs. Furthermore, the deformation sections 591 and 592 are formed integrally with the spring housing 51 as a plastic injection-molded part. Due to their dimensioning, shape, and their material properties, the deformation sections 591 and 592 are elastically deformable to such an extent that the spring housing 51 with the first end 55 of the return spring 53 attached thereto can execute slight radial movements relative to the fastening sections 59. The fastening sections 59 are each flattened on their side facing the spring housing 51 to form a stop surface 594, so that the possible radial movement of the spring housing 51 is limited. The gap between the stop surface 594 and the spring housing 51 in the unloaded state, i.e., the initial state without an external load, is larger than the gap between the belt shaft 2 and the bearing rings 10 and 11, so that the radial movements of the belt shaft 2 cannot lead to the spring housing 51 contacting the stop surfaces 594, and the belt shaft 2 runs on the bearing rings 10 and 11 beforehand during radial movements. This can prevent the stop surfaces 594 of the fastening sections 59 from being loaded by the radial forces exerted by the seatbelt on the belt shaft 2. The stop surfaces 594 are therefore only loaded when the spring housing 51 is loaded and deflected due to the radial forces exerted by the return spring 53.

FIG. 9 shows an alternative embodiment in which no bearing rings 10 and 11 are provided. Instead, the wall sections 3 and 4 are deformed by a reshaping such as a deep-drawing or punching process into bearing sections 31 and 41, which are thickened in the axial direction and have a correspondingly enlarged radial bearing surface.

FIG. 10 shows a further alternative embodiment in which, also, no bearing rings 10 and 11 are provided. Instead, the cover 52 of the spring cassette 5 has an annular, axially projecting collar 521 which projects into the bearing opening 12 of the left wall section 3 and encloses the belt shaft 2 in the section passing through the bearing opening 12.

Both solutions of FIGS. 9 and 10 for improving the bearing of the belt shaft 2 represent features independent of the mobility of the spring housing 51, which have the advantage that the previously provided bearing rings 10 and 11 can be omitted.

The proposed mobility of the spring housing 51 due to the provided deformation sections 591 and 592 has the advantage that the spring housing 51 itself can deflect and thereby compensate for the radial forces exerted by the return spring 53, so that the radial forces acting upon the belt shaft 2 can at least be reduced. Ideally, the return spring 53 then exerts only circumferential forces on the belt shaft 2, so that its rotational movement during winding and unwinding can be significantly improved. This allows the running and bearing of the belt shaft 2 to be realized more easily and, in particular, with less friction.

As can be seen in FIG. 1, the wall sections 3 and 4 are arranged on the same side—in this case on the left side of the blocking wall section 7. In this case, the right-hand wall section 4 with the bearing opening 13 in the illustration is at a smaller distance L1, and the left-hand wall section 3 with the bearing opening 12 in the illustration is at a larger distance L3, from the blocking wall section 7. The distance L2 between the two wall sections 3 and 4 with the bearing openings 12 and 13 then corresponds to the difference between the larger distance L3 and the smaller distance L1.

The bearing opening 12 in the wall section 3 at the larger distance L3 to the blocking wall section 7 has a larger bearing clearance D2—in this case of 1.07 mm—than the bearing opening 13 in the wall section 4 at the smaller distance L1 to the blocking wall section 7 with the smaller bearing clearance D1—in this case of 0.7 mm. Due to the proposed dimensioning of the bearing clearances D1 and D2, the belt shaft 2 runs as evenly as possible in the bearing openings 12 and 13 of the wall sections 3 and 4 even when the profile head 8 is blocked and the belt shaft 2 is deflected at an angle to the blocking head 8, which in turn leads to a more even loading of the wall sections 3 and 4 as well as of the belt shaft 2 in the region of the bearing openings 12 and 13.

Furthermore, the ratio of the distance L2 between the wall sections 3 and 4 to the distance L1 of the right wall section 4 to the blocking wall section 7 corresponds to approximately 2:1 or, in other words, a ratio of 2/3 to 1/3. Accordingly, the ratio of the distance L1 between the right wall section 4 and the blocking wall section 7 to the distance L3 between the left wall section 3 and the blocking wall section 7 is 2:3, which is ideally almost identical to the ratio of the bearing clearance D1 in the bearing opening 13 of the right wall section 4 to the bearing clearance D2 in the bearing opening 12 in the left wall section 3 of 0.7/1.07.

1. A belt retractor for a seat belt device of a motor vehicle with
a belt shaft rotatably that is mounted in a frame for winding up a seatbelt of the seatbelt device, wherein
the frame has two opposing wall sections oriented in parallel with one another and each having a bearing opening, in which wall sections the belt shaft is rotatably mounted, and
a spring housing secured to one of the wall sections and having a return spring arranged therein, which is connected to the spring housing by a first end and fixed for conjoint rotation to the belt shaft at a second end,
wherein
the spring housing, is radially elastically retained on the wall section.

2. A belt retractor according to claim 1, wherein
the spring housing has a main housing having fastening sections arranged radially on the outside, and
the fastening sections are connected to the main housing via resilient deformation sections.

3. A belt retractor according to claim 2, wherein
the fastening sections are each connected to the main housing via two deformation sections, and
the fastening sections, together with the deformation sections provided thereon, each delimit a free space to the main housing.

4. A belt retractor according to either claim 2, wherein
four fastening sections are provided, and in each case two fastening sections are arranged symmetrically to one another in relation to a central axis of the belt retractor.

5. A belt retractor according to claim 2, wherein
the fastening sections are arranged in such a way that they each form a stop, which limits the radial deflection of the spring housing made possible by the deformation sections.

6. A belt retractor according to any claim 1, wherein
the spring housing, on the side of the spring housing that faces the wall section, has a cover rigidly connected to the spring housing, and
the cover has an annular, axially projecting collar which is arranged such that it engages in the bearing openings and encompasses the section of the belt shaft that passes through the bearing opening.

7. A belt retractor according to claim 1, wherein
the wall section in the region of the bearing opening is thickened in the axial direction of the belt shaft.

8. A belt retractor according to claim 1, wherein
the return spring is connected by the second end to a coupling piece for conjoint rotation, which coupling piece is connected to the belt shaft for conjoint rotation.

9. A belt retractor according to claim 8, wherein
an axial spring which urges the coupling piece into a bearing of the spring housing is provided between the coupling piece and the belt shaft.

10. A belt retractor according to claim 9, wherein the bearing is a spherical bearing in the form of a hemisphere or partial sphere in the spring housing.

11. A belt retractor according to claim 9, wherein
the axial spring is a conical spring.

12. A belt retractor according to claim 11, wherein
the larger diameter of the conical spring is supported on the belt shaft.

13. A belt retractor according to claim 1, wherein
a force limiting device is provided which has a profile head that can be blocked by means of a blocking pawl in relation to a blocking wall section of the frame, and
the wall sections having the bearing openings are arranged on one side of the blocking wall section, and
the bearing clearance of the bearing opening in the wall section at the greater distance from the blocking wall section is greater than the bearing clearance of the bearing opening in the wall section at the smaller distance from the blocking wall section.
